(19) United States
(12) Patent Application Publication
(10) Pub. No.: US 2009/0171986 A1
(43) Pub. Date: Jul. 2, 2009

(54) TECHNIQUES FOR CONSTRUCTING SITEMAP OR HIERARCHICAL ORGANIZATION OF WEBPAGES OF A WEBSITE USING DECISION TREES

(75) Inventors: Krishna Prasad Chitrapura, Bangalore (IN); Pavan Kumar Ganganahalli Marulappa, Bangalore (IN); Krishna Leela Poola, Bangalore (IN); Mahesh Tiyyagura, Hyderabad (IN)

Correspondence Address: BEYER LAW GROUP LLP/YAHOO, PO BOX 1687, CUPERTINO, CA, 95015-1687, US

(73) Assignee: YAHOO! INC., Sunnyvale, CA (US)

(21) Appl. No.: 11/965,320

(22) Filed: Dec. 27, 2007

(51) Int. Cl. G06F 17/30

(52) U.S. Cl. 707/100; 707/E17.046

(57) ABSTRACT

A decision tree may be determined that is a site map for a domain of web pages. A clustering of a plurality of web pages of a domain is determined, in an unsupervised fashion, based on content-related features of the plurality of web pages. Each determined cluster includes a plurality of web pages, each of the plurality of web pages characterized by a resource locator and each of the resource locators being characterized by at least one resource locator token. The clustering is processed to organize indications of the content-related features of the plurality of web pages into a decision tree characterized by a plurality of nodes, each node characterized by a feature and a value, the feature being at least one of the resource locator tokens and the value being a value of that resource locator token.

### BACKGROUND

Supervised learning methods (such as decision trees, classification, etc.) are known to, for example, predict a value of a variable of an unknown instance (such as content-related features of a previously-unvisited web page) based on properties of known instances (such as content-related features of previously-visited web pages). Conventionally, supervised learning methods utilize supervision to generate training data. Using such supervised learning methods relative to web page content-related features can require a large amount of training data and, therefore, such an approach may generally not be efficiently scalable.

### SUMMARY

In accordance with an aspect, a decision tree may be determined that is a site map for a domain of web pages. A clustering of a plurality of web pages of a domain is determined, in an unsupervised fashion, based on content-related features of the plurality of web pages. Each determined cluster includes a plurality of web pages, each of the plurality of web pages characterized by a resource locator and each of the resource locators being characterized by at least one resource locator token. The clustering is processed to organize indications of the content-related features of the plurality of web pages into a decision tree characterized by a plurality of nodes, each node characterized by a feature and a value, the feature being at least one of the resource locator tokens and the value being a value of that resource locator token.

### BRIEF DESCRIPTION OF THE DRAWINGS

FIG. 1 is an architecture diagram that broadly illustrates an environment in which a decision tree may be generated, in an unsupervised manner, to represent a site map of a domain.

FIG. 2 is a flowchart illustrating an example of a process to create a site map decision tree in an unsupervised manner.

FIG. 3 illustrates an example of leaf nodes of a decision tree that is being built in a bottom up manner.

FIG. 4 illustrates a partially-built decision tree including a lower level where the nodes are the same as the clusters of a clustering and a next level up that includes combinations of the nodes at the lower level.

FIG. 5 illustrates a decision tree of nodes that may result from processing a clustering of web pages.

FIG. 6 is a simplified diagram of a network environment in which specific embodiments of the present invention may be implemented.

### DETAILED DESCRIPTION

The inventors have realized the desirability of determining an organization of web pages by building a decision tree using training data that has been automatically generated in an unsupervised manner. As a result, the generation of such decision trees may be highly scalable, such as may be desirable for use in analyzing web pages of the world wide web.

See, for example, “Induction of decision trees,” by J R Quinlan in Machine Learning, 1986. Examples of such analysis may include URL normalization, which includes generating a representative URL for a group of URLs. Another examples of such analysis may include duplicate detection: This includes detecting duplicate pages on the web in a scalable fashion.

A scalable crawler may use the decision tree to detect duplicate pages from the URLs of the pages without actually crawling to those pages. By using the decision tree to group and aggregate features, search relevance can be improved. The decision tree may also be used to in advertisement targeting, to serve relevant advertisements on unseen pages.

In general, the decision tree provides high recall and precision information extraction.

Broadly speaking, the training data may be generated by determining, in an unsupervised fashion, clusters of a plurality of “training” web pages based on content-related features of the plurality of web pages, such as content on the web page by stripping of the HTML tags. Content of the web page depending upon the application could also include the HTML tags. Each determined cluster includes a plurality of web pages, each of the plurality of web pages characterized by a resource locator and each of the resource locators having at least one resource locator token.

Information of the clustering is used as training data for generating a decision tree. More particularly, the clusters are processed to organize indications of the content-related features of the plurality of web pages into a decision tree characterized by a plurality of nodes. Each node of the decision tree is characterized by a feature and a value. The feature is at least one of the resource locator tokens, and the value is a value of that at least one resource locator token.

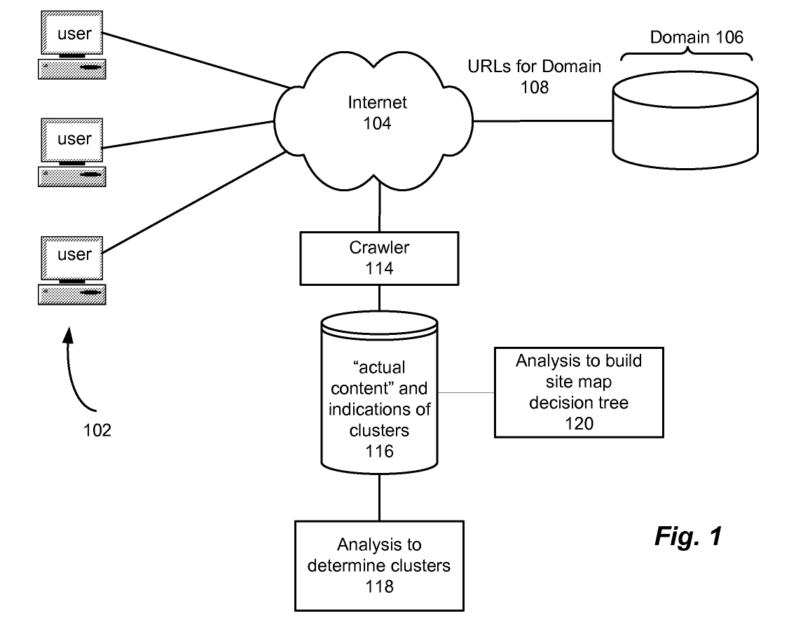

We first describe a general approach to building a decision tree using training data that has been automatically determined in an unsupervised manner. We then provide an illustrative example. The general approach is described with reference to FIG. 1, which is an architecture diagram that broadly illustrates an environment in which the decision tree may be generated in an unsupervised manner. Referring to FIG. 1, a “domain” 106 exists on the world wide web, such that when access requests having a domain identification in the universal resource locator (URL) match to that domain, the access requests are directed to one or more web servers associated with that domain. In the FIG. 1 example, the domain 106 is accessible via a network 104 (such as the internet) by users 102. For example, access requests 108 (such as HTTP access requests) may include URLs provided from browser programs executed by computing devices with which the users 102 are interacting. For example, the domain may correspond to “cnn.com” and the users 102 may be interacting with their browsers to cause access requests to be generated including URLs such as http://www.cnn.com/video/#/video/world/2007/10/18/sweeney.barham.saleh.intv.cnn, which may be a URL for which the domain corresponding to cnn.com can fulfill the access request.

FIG. 1 further illustrates a web crawler 112 that browses the web automatically, generating web accesses and receiving corresponding web page content. Web crawlers are known as used, for example, by search engines to visit numerous web pages. Other methods may be used as well to generate web accesses and receive corresponding web page content. The received web page content is saved in storage 116 for processing, such as generating an index usable by a search engine in responding to search queries.

An analysis process 118 processes the received web page content saved in storage 116. More specifically, the analysis process 118 includes processing to cluster web pages based on characteristics of the web page content. The clustering is an unsupervised process. In one example, the clustering of the analysis process 118 is generally for web pages that result from access requests corresponding to a particular domain.

Having determined the clusters, the web page content in storage 116 is indicated with a result of the cluster determination. Such an indication can have various uses. In the FIG. 1 example, the cluster determination indications are employed, along with resource locators corresponding to the web page content in storage 116, by an analysis process 120 to build a site map decision tree of the domain 106, in an unsupervised manner, using the resource locators and properties of the clustered web pages.

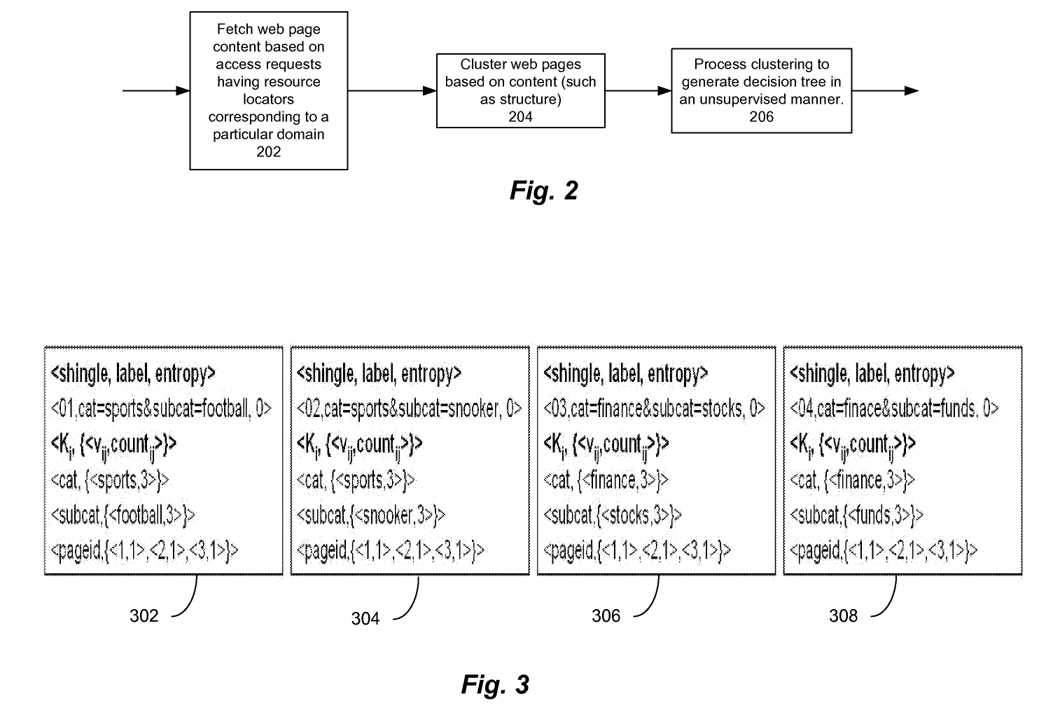

We now discuss, with reference to FIG. 2, an example of a process to create a site map decision tree in an unsupervised manner. FIG. 2 is a flowchart that illustrates the example of the process. At step 202, web page content is fetched based on access requests having resource locators corresponding to a particular domain. This may be, for example, by a web crawler such as the web crawler 112 of the FIG. 1 environment.

At step 204, the web pages are clustered based on content to cluster together web pages having similar content. More particularly, at least some of the web pages of the particular domain are clustered using an unsupervised clustering algorithm. Clustering of web pages is known. For example, the paper entitled “Syntactic Clustering of the Web,” by Broder et al., describes clustering using shingling to determine near-duplicate clusters. In general, any technique that clusters based on content similarity/dissimilarity may be acceptable. The paper entitled “A Short Survey of Structure Similarity Algorithms,” by D. Buttler, describes a number of known clustering algorithms. Using a shingling technique, in particular, web pages whose similarity measure is above a particular threshold (such as an 8/8 shingle match) may be clustered together. See, also, U.S. Patent Publication 20060112089 “Methods and apparatus for assessing web page decay” by Broder; Andrei Zary; et al and U.S. Pat. No. 6,119,124, entitled “Method for Clustering Closely Resembling DataObjects” by Andrei Broder, Steve Glassman, Greg Nelson, Mark Manasse, and Geoffrey Zweig.

Consider an example of the particular domain is foo.com, which has no other mirror sites and, hence, the domain name itself is the webmaster-id. Table 2 lists some example URLs for this domain, as well as an example clustering result (in this example, indicated by a cluster identification).

TABLE 2

| | Clus- |
|---|---|
| | ter |
| URL | ID |
| www.foo.com/showpage.do?cat=sports&subcat=football&pageid=1 | 01 |
| www.foo.com/showpage.do?cat=sports&subcat=football&pageid=2 | 01 |
| www.foo.com/showpage.do?cat=sports&subcat=football&pageid=3 | 01 |
| www.foo.com/showpage.do?cat=sports&subcat= | 02 |
| snooker&pageid=1 | |
| www.foo.com/showpage.do?cat=sports&subcat= | 02 |
| snooker&pageid=2 | |
| www.foo.com/showpage.do?cat=sports&subcat= | 02 |
| snooker&pageid=3 | |
| www.foo.com/showpage.do?cat=finance&subcat=stocks&pageid=1 | 03 |
| www.foo.com/showpage.do?cat=finance&subcat=stocks&pageid=2 | 03 |
| www.foo.com/showpage.do?cat=finance&subcat=stocks&pageid=3 | 03 |
| www.foo.com/showpage.do?cat=finance&subcat=funds&pageid=1 | 04 |
| www.foo.com/showpage.do?cat=finance&subcat=funds&pageid=2 | 04 |
| www.foo.com/showpage.do?cat=finance&subcat=funds&pageid=3 | 04 |

That is, the twelve retrieved web pages have been clustered into four clusters of three web pages each. Each shingle has been given an identification of 01, 02, 03 or 04. Still with reference to FIG. 2, having determined the clustering of web pages in an unsupervised manner, at step 206, the clustering is processed to generate a decision tree in an unsupervised manner. For example, the clustering may be processed to organize indications of the content-related features of the plurality of web pages into a decision tree. For example, as will be seen, in some examples, the indications of content-related features may include tokens of the resource locators (URLs) for the web pages. The decision tree is characterized by a plurality of nodes, and each node is characterized by a feature and a value, where the indications of content-related features are tokens of URLs. The feature characterizing a node may be at least one of the resource locator tokens and the value characterizing the node is a value for that at least one resource locator token.

Thus, for example, building the decision tree in a bottom-up manner, the leaf nodes of the decision tree may each be characterized by a feature that is common to all the URLs of a particular cluster, as illustrated in FIG. 3. Put another way, each leaf node is characterized by a feature that has a highest coincidence with the cluster (as exhibited, for example, by an entropy measure for the feature within the cluster).

In FIG. 3, each node (302, 304, 306 and 308) has been associated with a cluster, label, entropy and list of keys (tokens), key values and counts. For example, the features used in the analysis may be URL tokens generated from the host-name, static path, script name, and query-args. Below is an example URL and an example of corresponding tokens:

http://finance.yahoo.com/nasdaq/charts/search.asp?ticker=YHOO&start=mon&end=thu
|...........host-name...........|.......static......|....script.....|.....................query-args...................|

Features corresponding to the above URL and their values are shown below:
hostname_{—}0: com
hostname_{—}1: yahoo
hostname_{—}2: finance
static_path_{—}0: nasdaq
static_path_{—}1: charts
script_name: search.asp
dyn_ticker: YHOO
dyn_start: mon dyn_end: thu

Referring to FIG. 3, and taking cluster 302 as an example, the shingle (or cluster ID) is “01” and the label is “cat=sports&subcat=football,” as this happens to be the feature that exhibits the least entropy, since it occurs in all of the URLs of the cluster. (Entropy may be considered to be a measure of distribution of feature values, in which the lower the value, the less random or uncertain the distribution of features.)

One key for the cluster 302 is “cat,” for which the only value is “sports” with a count of three. Another key for the cluster 302 is “subcat,” for which the only value is “football,” again with a count of three. Another key for the cluster 302 is “page id.” The key “page id” has three values in the URLs of the cluster. One value is “1,” with a count of 1. Another value is “2,” with a count of 1. A final value for “page id” is “3,” with a count of 1.

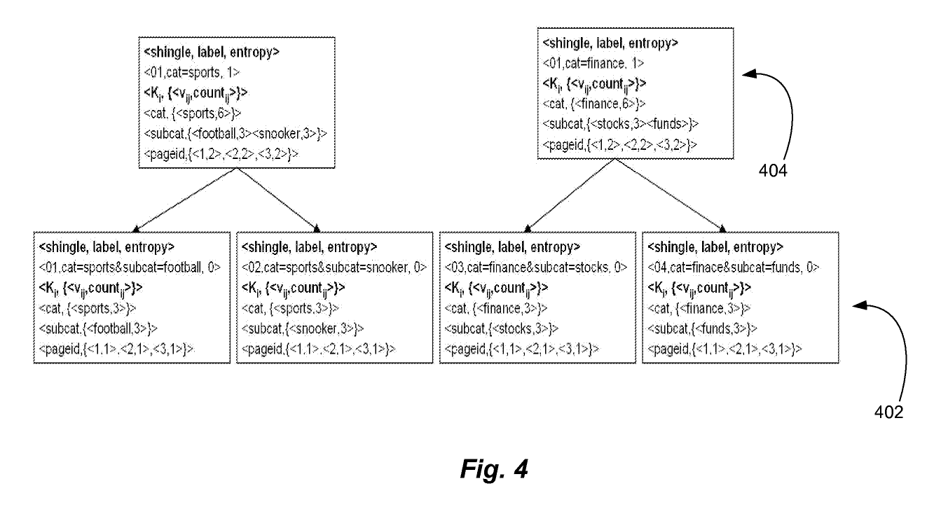

To generate the next level up, it is determined what other keys highly predict (are highly correlated to) various combinations of already-created nodes (i.e., of clusters 302, 304, 306 and 308), in general, ignoring the features used to determine the leaf nodes. Put another way, each node at the next level up is defined to specify a collective characterization of URLs of lower level nodes that are constituents of that next level up node. The combinations of clusters that can be highly predicted (or even most highly predicted) are designated as the nodes at the next level up. Thus, for example, FIG. 4 illustrates a partially-built decision tree including a lower level 402 where the nodes are the same as the clusters, and a next level up (404) that includes combinations of the nodes at the lower level. The process of defining the nodes of a “next level up” continues (i.e., further combining clusters of nodes from one level to determine the nodes at a next level up) until a level has only one node.

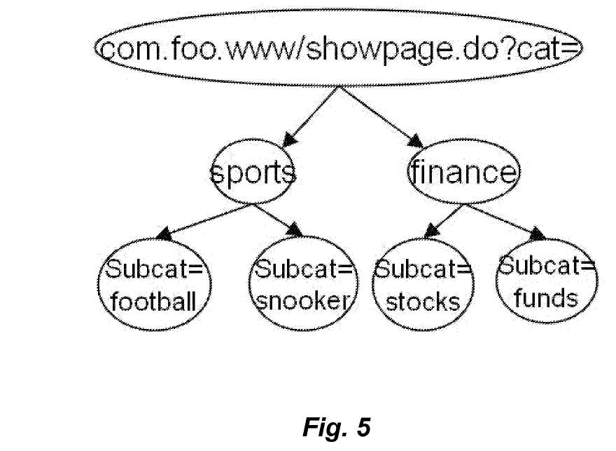

FIG. 5 illustrates a decision tree of nodes that may result from processing the clustering of Table 2. It can be seen that the FIG. 5 decision tree is a site map of the foo.com domain for which web page content was clustered.

It is further noted that it is known as well how to build a decision tree from top down. In one example, the top-down process starts with a dummy root node, including all of the URLs to be mapped (along with their labels) and splits the node based on the URL tokens to form multiple child nodes. These child nodes are further considered for top-down split until the nodes satisfy criteria like homogeneity (if the node is homogenous, no need to further split), minimum number of URLs (if the node has fewer URLs than a threshold, it is decided to not split that node further), and perhaps other criteria. It can be seen that the top down process is similar to the bottom up process. However, in general, some steps of the bottom up process can be parallelized, which can lead to more efficient processing. For example, the bottom up process, due to its parallelization, may be implemented using a scalable architecture such as MapReduce.

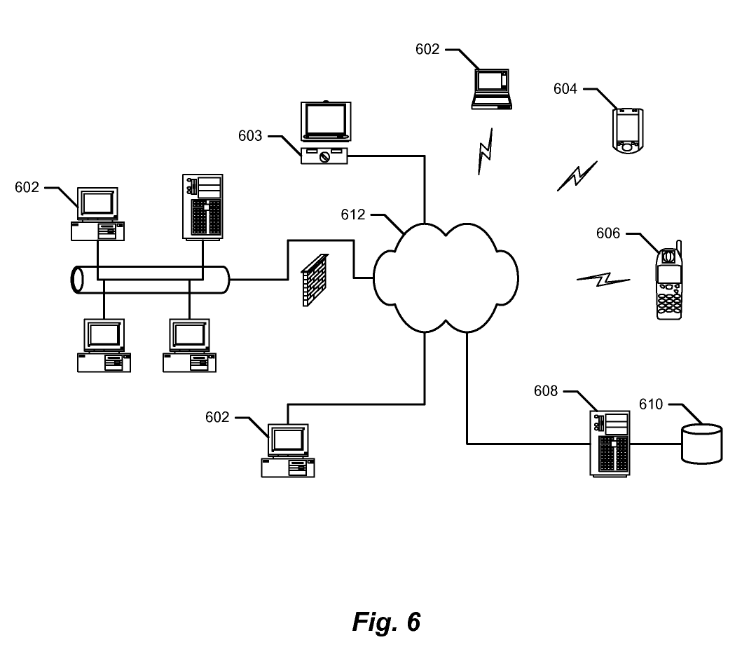

We have described a system/method to determine an organization of web pages by building a decision tree using training data that has been automatically generated in an unsupervised manner. Embodiments of the present invention may be employed to facilitate determination one ore more similarity classes in any of a wide variety of computing contexts. For example, as illustrated in FIG. 6, implementations are contemplated in which a diverse network environment may be employed, using any type of computer (e.g., desktop, laptop, tablet, etc.) 602, media computing platforms 603 (e.g., cable and satellite set top boxes and digital video recorders), handheld computing devices (e.g., PDAs) 604, cell phones 606, or any other type of computing or communication platform.

According to various embodiments, a method of determining the similarity class such as described herein may be implemented as a computer program product having a computer program embodied therein, suitable for execution locally, remotely or a combination of both. The remote aspect is illustrated in FIG. 6 by server 608 and data store 610 which, as will be understood, may correspond to multiple distributed devices and data stores.

The various aspects of the invention may also be practiced in a wide variety of network environments (represented by network 612) including, for example, TCP/IP-based networks, telecommunications networks, wireless networks, etc. In addition, the computer program instructions with which embodiments of the invention are implemented may be stored in any type of computer-readable media, and may be executed according to a variety of computing models including, for example, on a stand-alone computing device, or according to a distributed computing model in which various of the functionalities described herein may be effected or employed at different locations

What is claimed is:

1. A method of determining a decision tree that is a site map for a domain of web pages, comprising:
determining, in an unsupervised fashion, a clustering of a plurality of web pages of a domain based on content-related features of the plurality of web pages, each determined cluster including a plurality of web pages, each of the plurality of web pages characterized by a resource locator and each of the resource locators being characterized by at least one resource locator token; and
processing the clustering to organize indications of the content-related features of the plurality of web pages into a decision tree characterized by a plurality of nodes, each node characterized by a feature and a value, the feature being at least one of the resource locator tokens and the value being a value of that resource locator token.

2. The method of claim 1, wherein:
the step of determining a clustering includes shingling.

3. The method of claim 1, wherein:
the content-related features based on which the clustering is determined includes content of the web page not including HTML tags.

4. The method of claim 1, wherein:
the resource locator is a URL.

5. The method of claim 1, further comprising:
employing a crawler to gather the plurality of web pages.

6. The method of claim 1, wherein:
processing the clustering to organize indications of the content-related features of the plurality of web pages into a decision tree characterized by a plurality of nodes includes building the decision tree in a bottom-up manner.

7. The method of claim 6, wherein:
building the decision tree in a bottom-up manner includes beginning with a bottom level of the decision tree including nodes that correspond to clusters of the determined clustering.

8. The method of claim 7, wherein:
building the decision tree in a bottom-up manner further includes, to determine a next level up of the decision tree, determining one or more of the at least one resource locator that is highly correlated to combinations of nodes at the current level of the decision tree.

9. The method of claim 8, wherein:
building the decision tree in a bottom-up manner further includes determining that a next level of the decision tree is a top level of the decision tree based on the next level having only one node.

10. The method of claim 1, wherein:
processing the clustering to organize indications of the content-related features of the plurality of web pages into a decision tree characterized by a plurality of nodes includes building the decision tree in a top-down manner.

11. The method of claim 10, wherein:
building the decision tree in a top-down manner includes
starting with a dummy root node including all resource locators to be mapped to the decision tree;
forming multiple child nodes by splitting the dummy node based on resource locator tokens; and
choosing particular ones of the multiple child nodes for a next level down of the decision tree based on criteria including homogeneity and number of resource locators of the multiple child nodes.

12. A computer program product for determining a decision tree that is a site map for a domain of web pages, the computer program product comprising at least one computer-readable medium having computer program instructions stored therein which are operable to cause at least one computing device to:
determine, in an unsupervised fashion, a clustering of a plurality of web pages of a domain based on content-related features of the plurality of web pages, each determined cluster including a plurality of web pages, each of the plurality of web pages characterized by a resource locator and each of the resource locators being characterized by at least one resource locator token; and
process the clustering to organize indications of the content-related features of the plurality of web pages into a decision tree characterized by a plurality of nodes, each node characterized by a feature and a value, the feature being at least one of the resource locator tokens and the value being a value of that resource locator token.

13. The computer program product of claim 12, wherein:
the instructions which are operable to cause the at least one computing device to determine a clustering includes instructions which are operable to cause the at least one computing device to perform shingling.

14. The computer program product of claim 12, wherein:
the content-related features based on which the clustering is determined includes content of the web page not including HTML tags.

15. The computer program product of claim 12, wherein:
the resource locator is a URL.

16. The computer program product of claim 12, wherein the computer program instructions are further operable to cause at least one computing device to:
employ a crawler to gather the plurality of web pages.

17. The computer program product of claim 12, wherein:
the instructions which are operable to cause the at least one computing device to process the clustering to organize indications of the content-related features of the plurality of web pages into a decision tree characterized by a plurality of nodes includes computer program instructions which are operable to cause the at least one computing device to build the decision tree in a bottom-up manner.

18. The computer program product of claim 17, wherein:
the computer program instructions which are operable to cause the at least one computing device to build the decision tree in a bottom-up manner includes computer program instructions which are operable to cause the at least one computing device to begin with a bottom level of the decision tree including nodes that correspond to clusters of the determined clustering.

19. The computer program product of claim 18, wherein:
the computer program instructions which are operable to cause the at least one computing device to build the decision tree in a bottom-up manner further includes, to determine a next level up of the decision tree, the computer program instructions which are operable to cause the at least one computing device to determine one or more of the at least one resource locator that is highly correlated to combinations of nodes at the current level of the decision tree.

20. The computer program product of claim 19, wherein:
the computer program instructions which are operable to cause the at least one computing device to build the decision tree in a bottom-up manner further includes computer program instructions which are operable to cause the at least one computing device to determine that a next level of the decision tree is a top level of the decision tree based on the next level having only one node.

21. The computer program product of claim 12, wherein:
the computer program instructions which are operable to cause the at least one computing device to process the clustering to organize indications of the content-related features of the plurality of web pages into a decision tree characterized by a plurality of nodes includes computer program instructions which are operable to cause the at least one computing device to build the decision tree in a top-down manner.

22. The computer program product of claim 21, wherein:
computer program instructions which are operable to cause the at least one computing device to build the decision tree in a top-down manner includes computer program instructions which are operable to cause the at least one computing device to
start with a dummy root node including all resource locators to be mapped to the decision tree;
form multiple child nodes by splitting the dummy node based on resource locator tokens; and
choose particular ones of the multiple child nodes for a next level down of the decision tree based on criteria including homogeneity and number of resource locators of the multiple child nodes.

23. A computing system including at least one computing device, configured to determine a decision tree that is a site map for a domain of web pages, the at least one computing device configured to:
determine, in an unsupervised fashion, a clustering of a plurality of web pages of a domain based on content-related features of the plurality of web pages, each determined cluster including a plurality of web pages, each of the plurality of web pages characterized by a resource locator and each of the resource locators being characterized by at least one resource locator token; and
process the clustering to organize indications of the content-related features of the plurality of web pages into a decision tree characterized by a plurality of nodes, each node characterized by a feature and a value, the feature being at least one of the resource locator tokens and the value being a value of that resource locator token.
